(19) United States
(12) Patent Application Publication
(10) Pub. No.: US 2015/0190839 A1
(43) Pub. Date: Jul. 9, 2015

(54) CAULKING TIP ASSEMBLY

(71) Applicant: William Hunt, Kihei, HI (US)

(72) Inventor: William Hunt, Kihei, HI (US)

(21) Appl. No.: 14/150,557

(22) Filed: Jan. 8, 2014

(51) Int. Cl. B05C 17/005

(52) U.S. Cl. CPC B05C 17/00503

(57) ABSTRACT

The invention disclosed herein is directed to a caulking tip assembly adapted for controllably dispensing a caulking material from a caulked-filled canister or tube. The caulking tip assembly comprises a tapered nozzle that includes an attachment end section and a dispensing tip section. The attachment end section is removably attachable to a dispensing end portion of the canister or tube, and the dispensing tip section conically tapers to a tip. The caulking tip assembly further comprises an adjustable valve positioned, at least in part, within the tapered nozzle and between the attachment end section and the dispensing tip section of the tapered nozzle. The adjustable valve is rotatably adjustable between a fully open position and a fully closed position.

### TECHNICAL FIELD

The present invention relates generally to a caulking tip assembly for controllably dispensing a caulking material and, more particularly, to a caulking tip assembly that can be detachably connected to a dispensing end of a caulking tube or canister, and that allows for controllably dispensing of a caulking material from the caulk tube or canister.

### BACKGROUND OF THE INVENTION

A caulking tube or canister generally comprises a cylindrical container filled with a caulking or other mastic material. Caulking tubes generally include (1) a forward stationary wall with an affixed hollow plastic dispensing tip, and (2) a movable rear wall that can translate within the tube. The forward wall has an orifice through which the contained caulking or mastic material is expelled when a compressive force is exerted against the movable rear wall (typically by squeezing the lever of a loaded caulk gun).

Heretofore, a variety of caulking tip assemblies adapted for use with a caulking tube or canister have been contemplated. For example, U.S. Pat. No. 7,014,079 to Swann discloses a universal replacement tip for a caulking tube designed to replace an original caulking tube tip after the tip has been used, or in the event that the user wishes to use a tip that produces a different shape and/or thickness of caulking bead without the need for a special adapter. U.S. Pat. No. 6,076,712 to Esber et al. discloses a flexible caulk tube nozzle that includes a tapered nozzle end portion, an accordion flexible middle section, a caulk tube attachment portion, and a number of angled caulk tube gripping structures. U.S. Pat. No. 5,833,099 to Boaz et al. discloses a caulking nozzle that is removably attachable to a threaded male adapter positioned on the forward wall of a caulking tube. U.S. Pat. No. 5,346,380 to Ables discloses a caulking tube extension nozzle that is engagable to a caulking tube for facilitating the distribution of caulk onto hard-to-reach areas. U.S. Pat. No. 5,249,716 to O'Sullivan discloses a caulking nozzle assembly that includes a curved angle guide that fits over the caulk-dispensing tube.

Although many advancements have been made with respect to the design of new and alternative types of caulking tip assemblies, there is still a need in the art for new and improved caulking tip assemblies that can be detachably connected to a dispensing end of a canister or tube, and that allow for controllably dispensing of a caulking material from the caulk canister or tube. The present invention fulfills these needs and provides for further related advantages.

### SUMMARY OF THE INVENTION

In brief, the present invention in an embodiment is directed to a caulking tip assembly adapted for controllably dispensing a caulking material from a caulked-filled canister or tube. The caulking tip assembly comprises a tapered nozzle that includes an attachment end section and a dispensing tip section. The attachment end section is removably attachable to a dispensing end portion of the canister or tube, and the dispensing tip section conically tapers to a tip. The caulking tip assembly further comprises an adjustable valve positioned, at least in part, within the tapered nozzle and between the attachment end section and the dispensing tip section of the tapered nozzle. The adjustable valve is rotatably adjustable between a fully open position and a fully closed position.

In a further embodiment, the attachment end section of the tapered nozzle includes a flanged disc and is sized and configured to sealingly fit onto the dispensing end portion of the caulk-filled canister or tube such that a flange portion of the flanged disc circumferentially contacts the inner sidewall of the canister or tube, and wherein the flanged disc has a central opening that allows for passage of the caulking material into and through the tapered nozzle.

In another further embodiment, the attachment end section of the tapered nozzle includes a central opening, wherein the central opening is sized and configured to sealingly fit onto an outwardly protruding nipple positioned on the dispensing end portion of the canister or tube, and wherein the central opening allows for passage of the caulking material into and through the tapered nozzle.

These and other aspects, advantages and features of the present invention will become apparent from the detailed description set forth below, from the accompanying drawings, from the claims, and from principles that are embodied in the specific structures that are illustrated and described herein.

### BRIEF DESCRIPTION OF THE DRAWINGS

Like reference numerals are used to designate like parts and features throughout the several views of the drawings. While the valve design and function remains substantially the same, the adaptation to the caulk tube changes as shown throughout the drawings.

FIG. 1 is a side view of a caulking gun loaded with a caulk tube having a caulking tip assembly in accordance with an embodiment of the present invention.

FIG. 2A is a top view of a caulking tip assembly in accordance with an embodiment of the present invention.

FIG. 2B is a side view of the caulking tip assembly shown in FIG. 2A.

FIG. 3A is a top view of a caulking tip assembly in accordance with another embodiment of the present invention.

FIG. 3B is a side cross-sectional view of the caulking tip assembly shown in FIG. 3B.

FIG. 4A is a top view of a caulking tip assembly in accordance with yet another embodiment of the present invention.

FIG. 4B is a side view of a caulk tube that has been altered to enable the attachment of the caulking tip assembly shown in FIG. 4C.

FIG. 4C is a side cross-sectional view of the caulking tip assembly shown in FIG. 4A.

FIG. 5A is a top view of a caulking tip assembly in accordance with still another embodiment of the present invention.

FIG. 5B is a top view of the caulking tip assembly shown in FIG. 5A.

FIG. 6A is a top view of a valve gate in accordance with an embodiment of the present invention.

FIG. 6B is a side view of the valve gate shown in FIG. 6A.

FIG. 6C is a front view of the valve gate shown in FIGS. 6A and 6B.

FIG. 7 is an enlarged side cross-sectional view of a caulking tip assembly that depicts groove and mating protrusion features in accordance with an embodiment of the present invention.

### DETAILED DESCRIPTION OF THE INVENTION

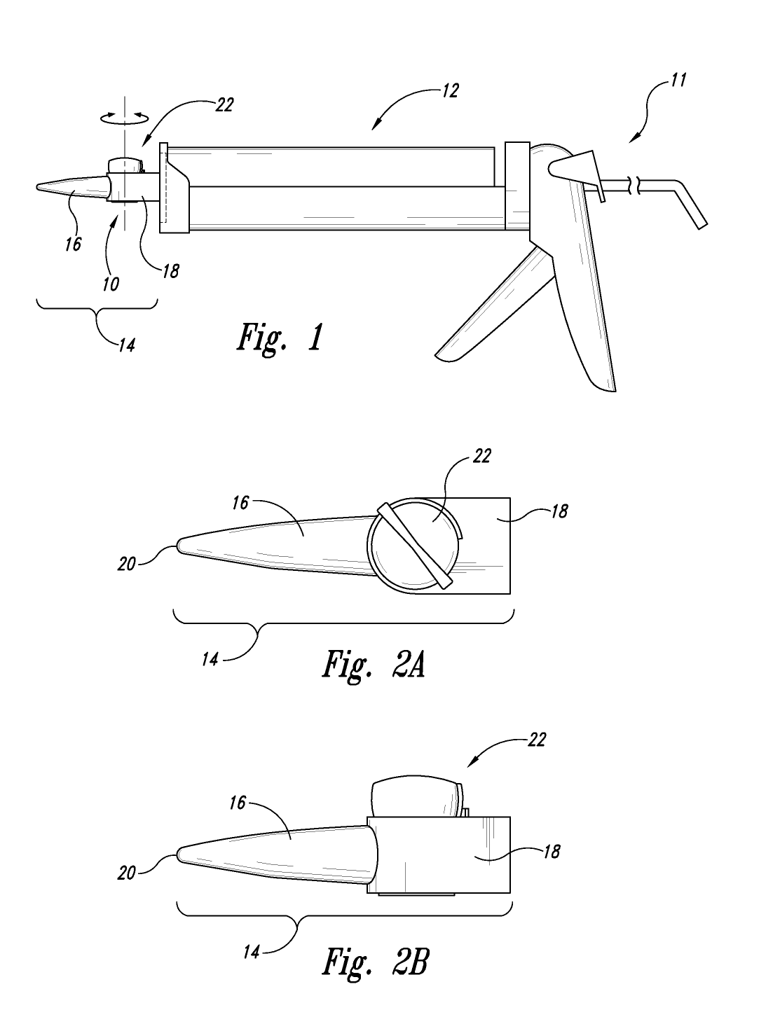

Referring now to the drawings wherein like reference numerals are used to designate like parts and features, the present invention in a first embodiment (and as best shown in FIGS. 1 and 2A-B) is directed to a caulking tip assembly 10 adapted for controllably dispensing a caulking material from a caulked-filled canister or tube 12. As shown, the caulking tip assembly 10 comprises a tapered nozzle 14 that includes a dispensing tip section 16 and an attachment end section 18. The attachment end section 18 is removably attachable to a dispensing end portion 19 of the canister or tube 12, and the dispensing tip section 16 conically tapers to a tip 20. The caulking tip assembly 10 further comprises an adjustable valve 22 positioned, at least in part, within the tapered nozzle 14 and between the attachment end section 18 and the dispensing tip section 16 of the tapered nozzle 14. As shown, the adjustable valve 22 is rotatably adjustable between a fully open position and a fully closed position. The tapered nozzle 14 is preferably made of a resilient plastic material such as, for example, low density polyethylene (LDPE), whereas the adjustable valve 22 is preferably made from a hard plastic material such as, for example, high density polyethylene (HDPE).

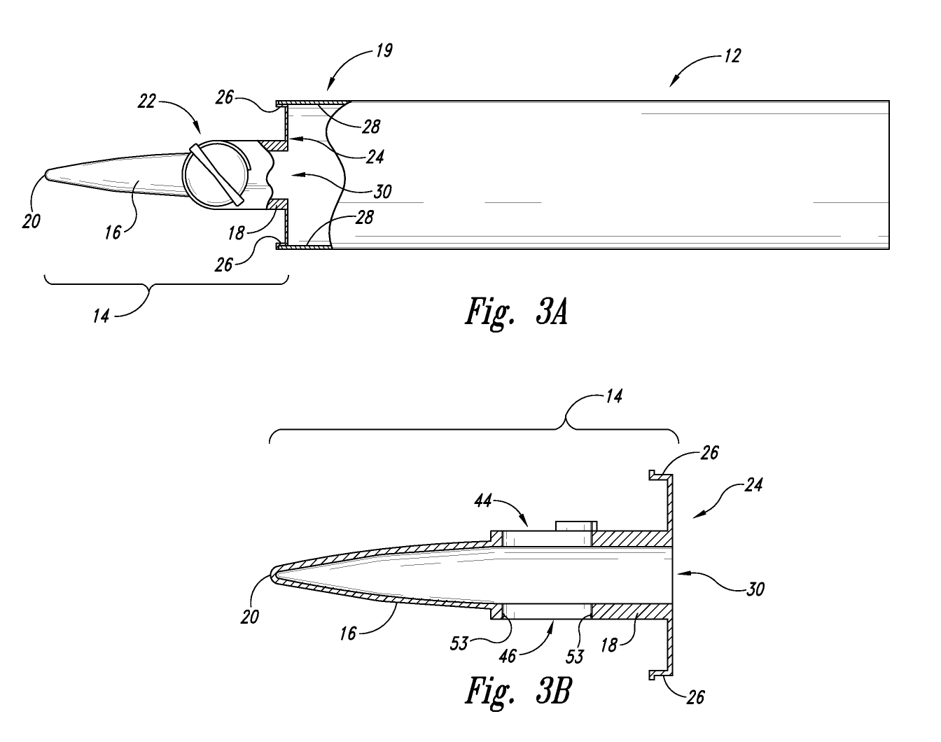

In a further embodiment (and as best shown in FIGS. 3A-B), the attachment end section 18 of the tapered nozzle 14 includes a flanged disc 24 sized and configured to sealingly fit onto the dispensing end portion 19 of the caulk-filled canister or tube 12 such that a flange portion 26 of the flanged disc 24 circumferentially contacts the inner sidewall 28 of the canister or tube 12, and wherein the flanged disc 24 has a central opening 30 that allows for passage of the caulking material into and through the tapered nozzle 14.

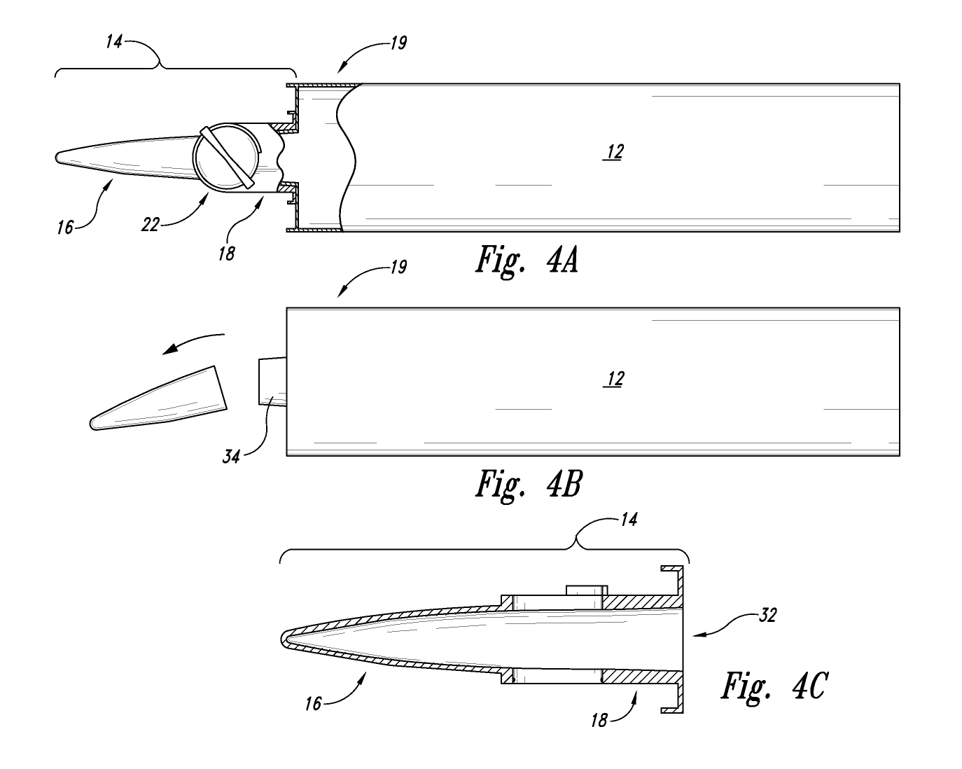

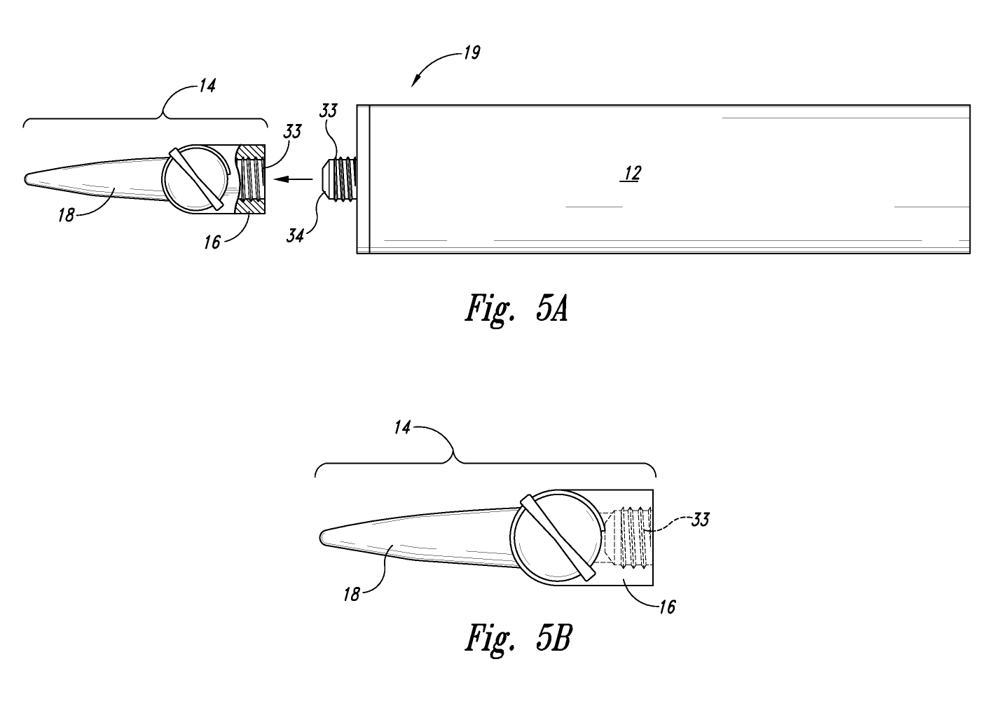

In another further embodiment (and as best shown in FIGS. 4A-C), the attachment end section 18 of the tapered nozzle 14 includes a central opening 32, wherein the central opening 32 is sized and configured to sealingly fit onto an outwardly protruding nipple 34 positioned on the dispensing end portion 19 of the canister or tube 12, and wherein the central opening 32 allows for passage of the caulking material (not shown) into and through the tapered nozzle 14. As best shown in FIGS. 5A-B, the outwardly protruding nipple 34 and the central opening 32 may both include threads 33 and, as such, are threadably engagable with each other.

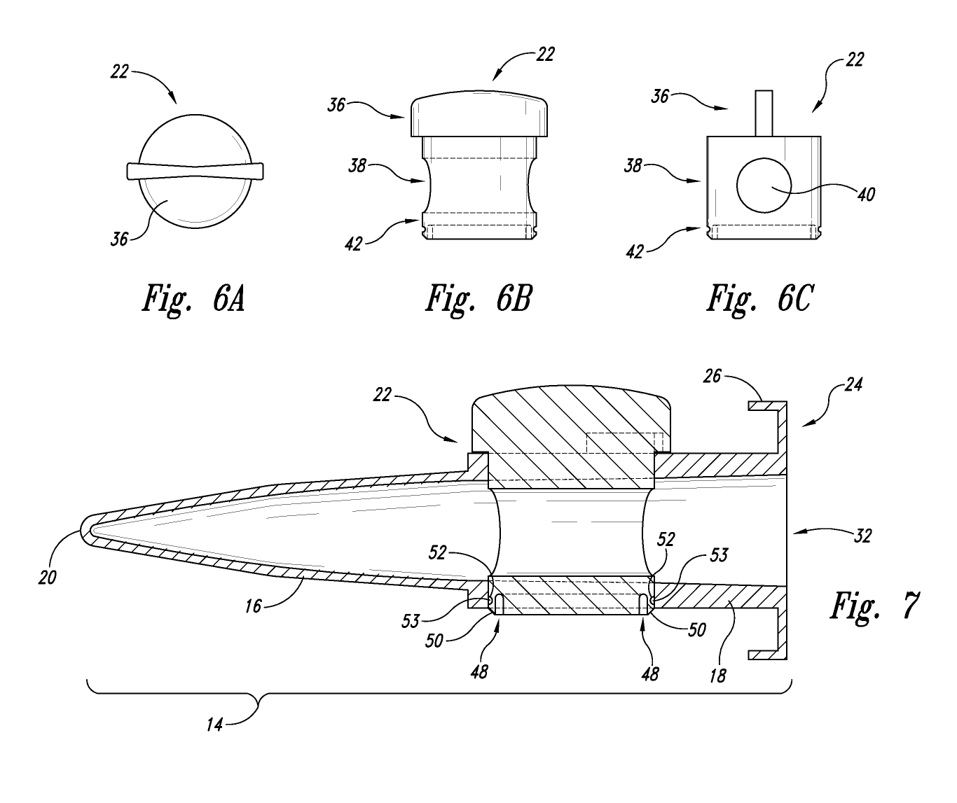

As best shown in FIGS. 6A-C and 7, the adjustable valve 22 preferably includes an upper handle section 36 that allows a user to rotatably adjust the valve between the fully open position and the fully closed position, a central section 38 within the tapered nozzle 14 that has a central passageway 40 that allows for passage of the caulking material (not shown) into and through the tapered nozzle 14 when the valve is in the fully open position, and a lower section 42. As shown, the upper handle 36 and lower 42 sections of the adjustable valve 22 are circular in shape and are connected to the tapered nozzle 14 by way of corresponding upper and lower circular openings 44, 46 (shown in FIG. 3B), wherein the upper and lower circular openings 44, 46 are positioned on the tapered nozzle 14 and confront each other.

As best shown in FIG. 7, the lower section 42 of the adjustable valve 22 has a circumferential recess 48 on its bottom that defines a circular, downwardly extending, and an inwardly compressible tang 50. The tang 50 further includes an outer circumferentially positioned groove 52, and wherein the outer groove 52 of the tang 50 is matingly engaged with a corresponding circumferential protrusion 53 positioned on the sidewall of the lower circular opening 46 of the tapered nozzle 14.

While the present invention has been described in the context of the embodiments illustrated and described herein, the invention may be embodied in other specific ways or in other specific forms without departing from its spirit or essential characteristics. Therefore, the described embodiments are to be considered in all respects as illustrative and not restrictive. The scope of the invention is, therefore, indicated by the appended claims rather than by the foregoing descriptions, and all changes that come within the meaning and range of equivalency of the claims are to be embraced within their scope.

What is claimed is:

1. A caulking tip assembly for controllably dispensing a caulking material from a canister or tube, comprising:
a tapered nozzle, wherein the tapered nozzle includes an attachment end section and a dispensing tip section, wherein the attachment end section is removably attachable to a dispensing end portion of the canister or tube, and wherein the dispensing tip section conically tapers to a tip;
an adjustable valve positioned, at least in part, within the tapered nozzle and between the attachment end section and the dispensing tip section of the tapered nozzle, wherein the adjustable valve is rotatably adjustable between a fully open position and a fully closed position.

2. The caulking tip assembly according to claim 1 wherein the attachment end section of the tapered nozzle includes a flanged disc sized and configured to sealingly fit onto the dispensing end portion of the canister or tube such that a flange portion of the flanged disc circumferentially contacts the inner sidewall of the canister or tube, and wherein the flanged disc has a central opening that allows for passage of the caulking material into and through the tapered nozzle.

3. The caulking tip assembly according to claim 1 wherein the attachment end section of the tapered nozzle includes a central opening, wherein the central opening is sized and configured to sealingly fit onto an outwardly protruding nipple positioned on the dispensing end portion of the canister or tube, and wherein the central opening allows for passage of the caulking material into and through the tapered nozzle.

4. The caulking tip assembly according to claim 3 wherein the outwardly protruding nipple and the central opening are threaded so as to be threadably engagable with each other.

5. The caulking tip assembly according to claim 1 wherein the adjustable valve includes an upper handle section that allows a user to rotatably adjust the valve between the fully open position and the fully closed position, a central section within the tapered nozzle that has a central passageway that allows for passage of the caulking material into and through the tapered nozzle when the valve is in the fully open position, and a lower section.

6. The caulking tip assembly according to claim 5 wherein the upper handle and lower sections of the adjustable valve are circular in shape and are connected to the tapered nozzle by way of corresponding upper and lower circular openings, wherein the upper and lower circular openings are positioned on the tapered nozzle and confront each other.

7. The caulking tip assembly according to claim 6 wherein the lower section of the adjustable valve has a circumferential recess on its bottom that defines a circular, downwardly extending, and an inwardly compressible tang.

8. The caulking tip assembly according to claim 7 wherein the tang further includes an outer circumferentially positioned groove, and wherein the outer groove of the tang is matingly engaged with a corresponding circumferential protrusion positioned on the sidewall of the lower circular opening of the tapered nozzle.
